(19) United States
(12) Patent Application Publication
(10) Pub. No.: US 2018/0241878 A1
(43) Pub. Date: Aug. 23, 2018

(54) SYSTEM AND METHOD FOR MONITORING COMMUNICATIONS AND/OR IDENTIFYING IMPOSTERS AND/OR CONFIRMING AUTHENTICITY OF AN ORGANIZATIONAL AFFILIATION CLAIM/ASSERTION

(71) Applicants: Yigal JACK, Bridgend (GB); Ofer LAVI, Herzliya (IL)

(72) Inventors: Yigal JACK, Bridgend (GB); Ofer LAVI, Herzliya (IL)

(21) Appl. No.: 15/753,572

(22) PCT Filed: Aug. 18, 2016
(86) PCT No.: PCT/IL2016/050912

§ 371 Date: Feb. 20, 2018

Related U.S. Application Data
(60) Provisional application No. 62/207,444, filed on Aug. 20, 2015.
(60) Provisional application No. 62/256,204, filed on Nov. 17, 2015.

(51) Int. Cl. H04M 3/436; H04M 3/42; H04W 4/14; H04W 12/12; G06F 17/30

(52) U.S. Cl. CPC H04M 3/4365; H04M 3/42382; H04W 4/14; H04W 12/12; H04M 7/0012; H04M 2203/558; H04M 2203/6027; H04M 2203/6045; G06F 17/30964

(57) ABSTRACT

System and method operative for monitoring communications and identifying imposter tx communicants who are pretending to contact an rx end user, from a telephone line associated with an organization which the imposter tx is not really calling from. Also, system and method for confirming authenticity of an organizational affiliation claim (claimed organizational affiliation), comprising providing a database of organizations, using a server/processor to access the database; and, via a channel of communication to end-users allowing end-users to receive from the processor an authentication of the claimed organizational affiliation.

### RELATED APPLICATIONS

Priority is claimed from U.S. Provisional Patent Application No. 62/207,444 entitled “System and method for confirming authenticity of an organizational affiliation claim” and filed 20 Aug. 2015 and from U.S. Provisional Patent Application No. 62/256,204 entitled “Systems and methods for monitoring communications including identification of imposters” filed 17 Nov. 2015, both of which are hereby incorporated by reference in their entirety.

### FIELD OF THIS DISCLOSURE

The present invention relates generally to authentication and more particularly to authentication of communicators.

### BACKGROUND

Vishing or voice phishing includes using the telephone to scam a user by pretending to be a legitimate business.

Pindrop.com offers a service, said to be patented, that “analyzes phone calls to identify malicious behavior and verify legitimate callers. Phoneprinting is at the heart of Pindrop's Call Center Anti-Fraud solutions, used by number of largest banks, insurers, brokerages and retailers in the US to detect fraud and verify customers. Phoneprinting takes an audio call and breaks it down into 147 unique call features to create a distinctive identifier for each caller. Pindrop Phoneprinting reveals: CALL TYPE: Is the caller using a cell, landline, or VoIP phone? Pindrop research indicates that 53% of fraudulent calls are made using a VoIP line, compared with only 7.2% of legitimate calls. GEO LOCATION: Where is this call really coming from? Is it international or domestic? Does the location indicated by the call audio match the phone number reported by Caller ID? UNIQUE PHONE: Has this caller been seen before? Fraudsters often change phone numbers, but it is much harder to change the audio characteristics that Pindrop uses to create a unique identifier for the call audio characteristics.

### SUMMARY

Certain embodiments seek to provide a system and method for monitoring communications and/or identifying imposters and/or confirming authenticity of a claim, made legitimately or alternatively by an imposter, of an affiliation between the legitimate person/entity or imposter, and a certain organization. For example, a telephone communicant or service provider making a house call may present herself or himself as being a service representative of company X.

There is thus provided, in accordance with at least one embodiment of the present invention, a system, method or computer product operative for monitoring communications and identifying imposter tx communicants who are pretending to contact an rx end user from a telephone line associated with an organization which the imposter tx is not really calling from.

There is also provided, in accordance with at least one embodiment of the present invention, a system, method or computer product operative for confirming authenticity of an organizational affiliation claim (claimed organizational affiliation), and comprising: Providing a database of organizations; Using a server/processor to access the database; and—Via a channel of communication to end-users—allowing end-users to receive from the processor an authentication of the claimed organizational affiliation.

Also provided, excluding signals, is a computer program comprising computer program code means for performing any of the methods shown and described herein when said program is run on at least one computer; and a computer program product, comprising a typically non-transitory computer-usable or -readable medium e.g. non-transitory computer-usable or -readable storage medium, typically tangible, having a computer readable program code embodied therein, said computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with some or all of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules shown and described herein may include any one or combination or plurality of: a server, a data processor, a memory/computer storage, a communication interface, a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may where-ever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of at least one computer/s or computing system/s, or processor/s or similar electronic computing device/s, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate information as described herein and/or to perform functionalities described herein and/or to implement any engine, interface or other system described herein. Any suitable computerized data storage e.g. computer memory may be used to store information received by or generated by the systems shown and described herein.

Functionalities shown and described herein may be divided between a server computer and a plurality of client computers. These or any other computerized components shown and described herein may communicate between themselves via a suitable computer network.

### BRIEF DESCRIPTION OF DRAWINGS

FIG. 1 illustrates an example flow for a situation in which a genuine tx calls rx from extension of registered organization.

FIG. 2 illustrates an example flow for a situation in which an imposter tx calls rx, seemingly from mobile phone, VOIP client, or extension of registered organization.

FIGS. 3-10 are diagrams illustrating aspects of embodiments of the present invention, each element of which may be provided separately or in any suitable combination.

FIGS. 11-14 are flow diagrams including a general flow diagram and an example of a specific embodiment thereof, both for an imposter call and for a genuine call, all in accordance with certain embodiments of the present invention.

Methods and systems included in the scope of the present invention may include some (e.g. any suitable subset) or all of the functional blocks shown in the specifically illustrated implementations by way of example, in any suitable order e.g. as shown.

Computational, functional or logical components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Each functionality or method herein may be implemented in software, firmware, hardware or any combination thereof. Functionality or operations stipulated as being software-implemented may alternatively be wholly or fully implemented by an equivalent hardware or firmware module and vice-versa. Any logical functionality described herein may be implemented as a real time application if and as appropriate and which may employ any suitable architectural option such as but not limited to FPGA, ASIC or DSP or any suitable combination thereof.

Any hardware component mentioned herein may in fact include either one or more hardware devices e.g. chips, which may be co-located or remote from one another.

Any method described herein is intended to include within the scope of the embodiments of the present invention also any software or computer program performing some or all of the method's operations, including a mobile application, platform or operating system e.g. as stored in a medium, as well as combining the computer program with a hardware device to perform some or all of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION

The following methods are provided, according to certain embodiments (Each flow herein may include some or all of the specified operations, suitably ordered e.g. as shown):

An example integration procedure that an integrator might perform when s/he integrates or registers organization x, e.g. preparatory to performing the methods of Flowcharts 1, 2, is described further on; the flowcharts 1, 2 below assume that the server has already registered organization x, which has 1000 extensions (say), in the system.

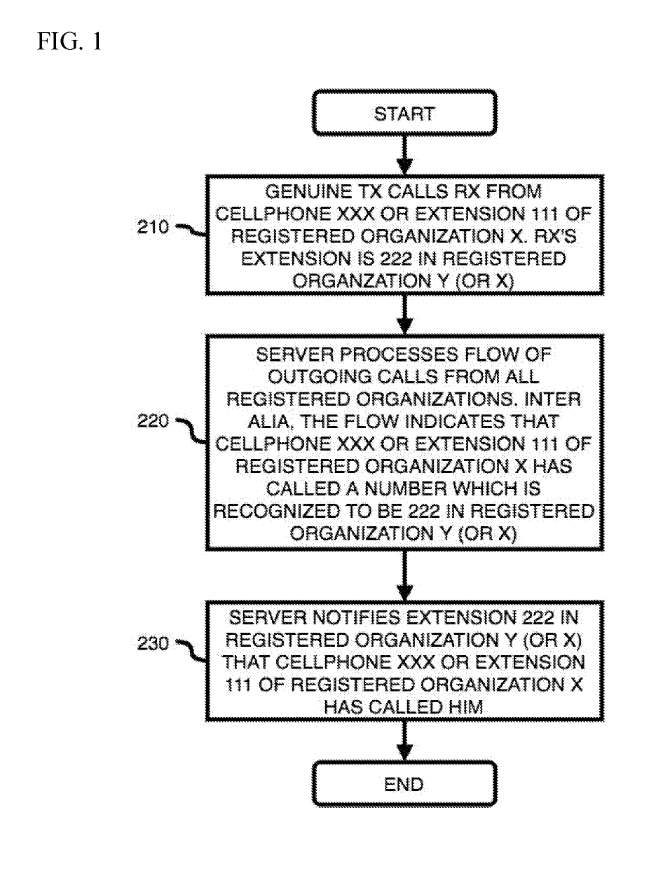

FIG. 1 illustrates an example flow for a situation in which a genuine tx calls rx from extension of registered organization. The method of FIG. 1 typically includes some or all of the following operations, suitably ordered e.g. as shown:

210: genuine tx calls rx from cellphone xxx or extension 111 of registered organization x. rx's extension is 222 in registered organization y (or x).

220: server processes flow of outgoing calls from all registered organizations. Inter alia, the flow indicates that cellphone xxx or extension 111 of registered organization x has called a number which is recognized to be 222 in registered organization y (or x).

230: Server notifies extension 222 in registered organization y (or x) that cellphone xxx or extension 111 of registered organization x has called him

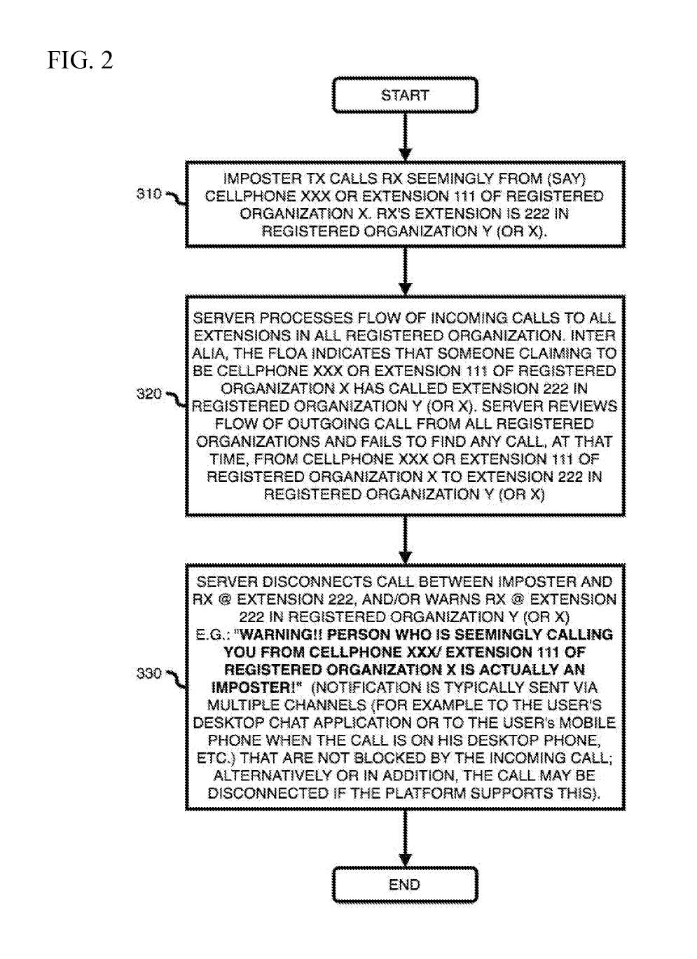

FIG. 2 illustrates an example flow for a situation in which an imposter tx calls rx, seemingly from mobile phone, VOIP client, or extension of registered organization. The method of FIG. 2 typically includes some or all of the following operations, suitably ordered e.g. as shown:

310: imposter tx calls rx, seemingly from (say) cellphone xxx or extension 111 of registered organization x. rx's extension is 222 in registered organization y (or x).

320: server processes flow of incoming calls to all extensions in all registered organizations. Inter alia, the flow indicates that someone claiming to be cellphone xxx or extension 111 of registered organization x has called extension 222 in registered organization y (or x). server reviews flow of outgoing calls from all registered organizations and fails to find any call, at that time, from cellphone xxx or extension 111 of registered organization x to extension 222 in registered organization y (or x)

330: server disconnects call between imposter and rx @ extension 222, and/or warns rx @ extension 222 in registered organization y (or x) e.g.: warning!! Person who is seemingly calling you from cellphone xxx/extension 111 of registered organization x is actually an Imposter! (notification is typically be sent via multiple channels (for example to the user's desktop chat application, or to the user's mobile phone when the call is on his desktop phone, etc.) that are not blocked by the incoming call; alternatively or in addition, the call may be disconnected if the platform supports this).

The applicability of the above flowcharts is in no way limited to calls that originate from an actual extension, in the sense of a phone connected to the organization's phone exchange. As the flowcharts indicate, calls may also come from a mobile phone or VOIP client (a.k.a. “soft phone”) e.g. as described in detail below.

Certain embodiments' solution allows users to confirm the authenticity of any service representative or “claimant” claiming to belong to a certain organization or corporation. Whenever a service representative makes such a claim (on a telephone call, a house visit, via a text message, email, etc.) the user simply asks the representative to use certain embodiments' solution to confirm that he actually belongs to the organization which he claims to represent. The representative then provides the user's mobile phone number to certain embodiments' Confirmation of Authenticity Service (CoAS), or the end-user provides his contact particulars e.g. email, phone, facebook etc., directly to the CoAS or in some way not via the claimant. This can be done via:
A. Certain embodiments' service portal
B. The organization/corporation portal which communicates with the CoAS via an API
C. Certain embodiments' service smartphone application

The CoAS then sends the user a secure message using any suitable communication technology, protocol or channel, confirming that the representative indeed works for the claimed organization/corporation.

Certain embodiment's solution further allows corporate employees to confirm the authenticity of any call made from a corporate number (IT, HR, security, etc.) or employee claiming to belong to an organization or corporation. Certain embodiments' solution handles both intra-corporate and inter-corporate calls.

The certain embodiments' intra-corporate solution provides the means to automatically send identity authentication information when a call is made between corporate users. This can be done when:
A. A corporate user calls another corporate user
B. A corporate user calls a conference room//voice bridge

These calls can be made via:
A. a CoA service-enabled mobile phone
B. the CoA service-enabled corporate PABX
C. a CoA service-enabled VOIP client

Certain embodiments' Certification of Authenticity Service (CoAS) then sends the called parties a secure or personalized message confirming that the caller indeed works for the organization/corporation. The message can be sent via any communication technology, protocol or channel appropriate for corporate users (e.g. desktop clients, corporate IM services, personalized text messages, security-token based notification (time-synchronized OTP), notifications with voice signatures, pagers) which may also take into consideration the user's presence and location information (e.g. at their workstation or away from it, at a meeting, out of the office).

Certain embodiments' inter-corporate solution further provides the means to validate incoming calls when a call is made between two corporate users belonging to separate organizations. This can be done when a corporate user receives a call via:
A. a CoA service-enabled mobile phone
B. the CoA service-enabled corporate PABX
C. a CoA service-enabled VOIP client

When this happens the client (or PABX) sends the incoming call's caller-ID information to the certain embodiments' Confirmation of Authenticity Service (CoAS) which will indicate whether the call is legitimate, fake, or unknown to the certain embodiments' service.

Flows may include registration flows and/or Confirmation of Authenticity (CoA) flows.

Registration flows for end-user may be provided and may include some or all of the following. Suitable registration flows for organizations to which affiliation is to be authenticated, may also be provided. The end user registration flow may be identical for all employees of the corporate, be they callers or the called party.

SmartPhone Flow—Stand Alone App May Include Some or all of the Following Operations, Suitably Ordered e.g. as Shown:
1. User installs our app on their phone
2. User runs our app on their phone
3. The app requests the user to enter their phone number
4. The user enters the phone number
5. The app sends a request to the server to validate the phone number (optionally over a secure connection). Responsively validation occurs e.g as per some or all of operations 6-9 below.
6. The server sends a text message to the given phone number with a verification code
7. The user enters the code from the text message into our app
8. The app sends the code back to the server (optionally over a secure connection) which determines if it's valid and responds to the app accordingly.
9. The server then records some or all of the following for the user in a database associated with a server:
   a. Phone number
   b. Device Identifier
   c. Push token
   d. Mobile platform type
   e. Mobile platform version
   f. (and a few other pieces of information like the user's language, the client version, etc.)

Additional operations may include some or all of:
10. The server then optionally checks whether the user's number is assigned in the system to any corporation. If this is the case the server records this corporate affiliation as part of the user's information.
11. The server responds to the client, stating whether the code was correct or incorrect, and indicates any additional operations that may be performed by the client. The specific additional operations are configurable per corporate and may include at least any combination of the following:
   a. Select personalized voice signature:
      i. In this case the client will prompt the user to record a personalized voice signature.
      ii. This voice signature is then stored on the client and may also be sent securely to the server.
      iii. This voice signature may be used when the user later receives a CoA from the server. This ensures that the CoA is indeed received through our application and not from a different application installed on the phone masquerading as our app (by having the same icon, name, etc.)
   b. Select personalized textual pass-phrase:
      iv. In this case the client will prompt the user to enter a personalized textual pass-phrase.
      v. This pass-phrase is then securely sent to the server.
      vi. This pass-phrase may be used when the user later receives a CoA from the server. This ensures that CoAs received over non-secure connections (such as SMS, Flash SMS, MMS) are indeed sent from our service.
   c. Select personalized image:
      vii. In this case the client will prompt the user to provide a personalized image (either from the phone's gallery or via the phone's camera).
      viii. This image is then stored on the client and may also be sent securely to the server.
      ix. This image may be used when the user later receives a CoA from the server. This ensures that CoAs received over non-secure connections (such as MMS) are indeed sent from our service.

SmartPhone Flow—SDK May Include Some or all of the Following Operations, Suitably Ordered e.g. as Shown:
1. User installs a corporation's app which includes our SDK on their phone
2. User runs the app on their phone
3. The app requests the user to enter their phone number
4. The user enters the phone number
5. The app sends a request to the server via the SDK to validate the phone number (optionally over a secure connection). Responsively validation occurs e.g as per some or all of operations 6-9 below.
6. The server sends a text message to the given phone number with a verification code
7. The user enters the code from the text message into the app
8. The app sends the code back to the server via the SDK (optionally over a secure connection) which determines if it's valid and responds to the app accordingly.
9. The server then records e.g. in a database associated with the server, suitable data including but not necessarily limited to some or all of the following for the user:
   a. Phone number
   b. Device Identifier
   c. Push token
   d. Mobile platform type
   e. Mobile platform version
   f. User's language
   g. Client version

Additional operations may include some or all of:
10. The server responds to the client, stating whether the code was correct or incorrect, and indicates any additional operations that may be performed by the client. The specific additional operations are configurable per corporate and may include at least any of the following:
   a. Select personalized voice signature:
      i. In this case the client will prompt the user to record a personalized voice signature.
      ii. This voice signature is then stored on the client and may also be sent to the server.
      iii. This voice signature may be used when the user later receives a CoA from the server. This ensures that the CoA is indeed received through our application and not from a different application installed on the phone masquerading as our app (by having the same icon, name, etc.)
   b. Select personalized textual pass-phrase:
      i. In this case the client will prompt the user to enter a personalized textual pass-phrase.
      ii. This pass-phrase is then sent to the server.
      iii. This pass-phrase may be used when the user later receives a CoA from the server. This ensures that CoAs received over non-secure connections (such as SMS, Flash SMS, MMS) are indeed sent from our service.
   c. Select personalized image:
      i. In this case the client will prompt the user to provide a personalized image (either from the phone's gallery or via the phone's camera).
      ii. This image is then stored on the client and may also be sent to the server. This image may be used when the user later receives a CoA from the server. This ensures that CoAs received over non-secure connections (such as MMS) are indeed sent from our service.

Web Browser Flow—Facebook May Include Some or all of the Following Operations:
1. User adds a dedicated Facebook app to their Facebook account
2. User runs the Facebook app
3. The app requests the user to enter their phone number
4. The user enters the phone number
5. The app sends a request to the server to validate the phone number (optionally over a secure connection). Responsively validation occurs e.g as per some or all of operations 6-9 below.
6. The server sends a text message to the given phone number with a verification code
7. The user enters the code from the text message into the Facebook app
8. The app sends the code back to the server (optionally over a secure connection) which determines if it's valid and responds to the app accordingly.
9. The server then records e.g. in a database associated with the server, suitable data including but not necessarily limited to some or all of the following for the user:
   a. Phone number
   b. Facebook User ID
   c. User's language
   d. App version

Confirmation of Authenticity (CoA) flows may include some or all of the following flows:

Phone Call Flow May Include Some or all of the Following Operations, Suitably Ordered e.g. as Shown:
1. User receives incoming call
2. Caller claims to be a representative of SomeCorp
3. User asks the caller/claimant to provide CoA using our service
4. The caller/claimant logs into our widget/portal/service app (using the username and password provided during the post-vetting representative registration phase) to enter the user's phone number and (optionally) a textual message (e.g. “This is Dan from SomeCorp—I'd like to arrange a technician house call to service our equipment”)—this information is then:
   a. Relayed to the CoAS via one of our APIs, and
   b. Stored in a database associated with the CoAS
5. Our portal looks for the user's phone number in the database and locates the relevant information with which to communicate with the user (phone platform type and version, identifier, etc). This information is based on the data received from the user (phone number, device identifier, push token, mobile platform type, mobile platform version, user's language, client version, etc.) as part of the registration flow.
6. Optional: the representative receives from our widget/portal/service app a verification code
7. Our portal (typically only if the caller/claimant is recognized by the system as being a representative of SomeCorp) sends a secure notification (meaning that the notifications cannot be forged or sent by another party), e.g. using the user's push token, to the user's device e.g. containing some or all of:
   a. SomeCorp's name
   b. The verification code from item #6 above (optional)
   c. The representative's name (optional)
   d. The textual message entered by the representative (optional)
   e. The country where SomeCorp is registered (optional)
8. Optional: the user may ask the representative for the verification code.

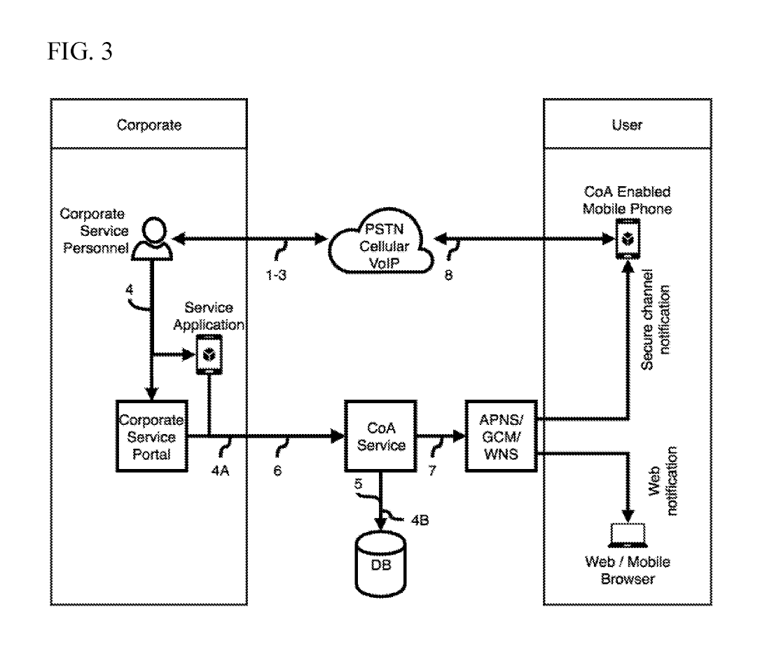

FIG. 3 depicts the various components and connections in use by the Confirmation of Authenticity (CoA) Phone Call flow according to an embodiment of the solution.

SMS Flow May Include Some or all of the Following Operations, Suitably Ordered e.g. as shown:
1. User receives a text message claiming to be from a representative of SomeCorp
2. User asks the representative to provide CoA using our service
3. The representative uses our widget/portal/service app to enter the user's phone number and (optionally) a textual message (e.g. “This is Dan from SomeCorp—I'd like to arrange a technician house call to service our equipment”)—this information is then:
   a. Relayed to the CoAS via one of our APIs, and
   b. Stored in a database associated with the CoAS
4. Our portal looks for the user's phone number in the database and locates the relevant information with which to communicate with the user (e.g. phone platform type and version, identifier, etc). This information is based on the data received from the user (phone number, device identifier, push token, mobile platform type, mobile platform version, user's language, client version, etc.) as part of the registration flow.
5. Optional: the representative receives from our widget/portal/service app a verification code
6. Our portal sends a secure notification (meaning that the notifications cannot be forged or sent by another party), e.g. using the user's push token, to the user's device containing at least one of:
   a. SomeCorp's name
   b. The verification code form item #5 above (optional)
   c. The representative's name (optional)
   d. The textual message entered by the representative (optional)
   e. The country where SomeCorp is registered (optional)
7. Optional: the user may ask the representative for the verification code

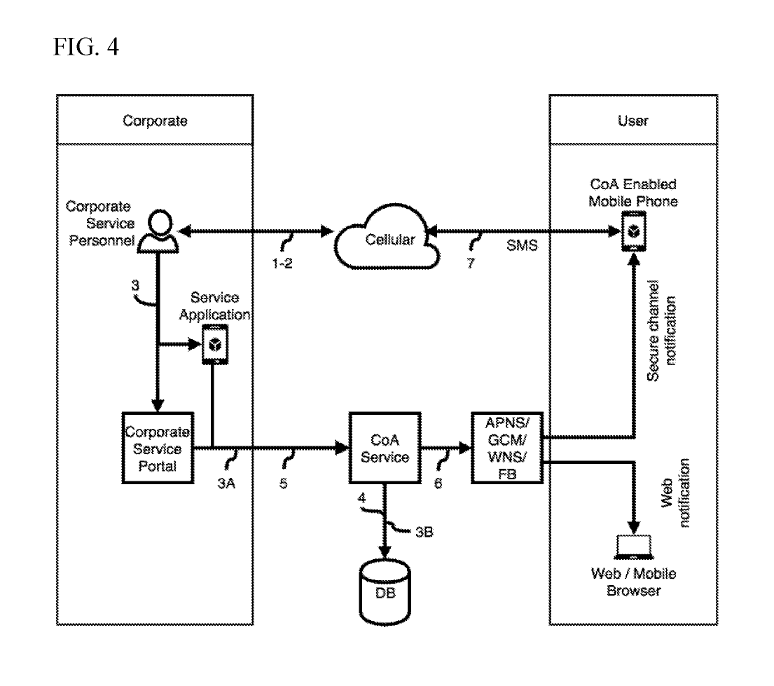

FIG. 4 depicts the various components and connections in use by the Confirmation of Authenticity (CoA) SMS flow according to an embodiment of the solution:

Home Service Flow (Physical Presence of Claimant and End-User at Same Premises) May Include Some or all of the Following Operations, Suitably Ordered e.g. as Shown:
1. A person claiming to be a representative of SomeCorp knocks on user's door
2. User asks the representative to provide CoA using our service
3. The representative uses either:
   a. our widget/portal/service app to enter the user's phone number and (optionally) a textual message (e.g. “This is Dan from SomeCorp—I'd like to arrange a technician house call to service our equipment”)—this information is then:
      i. Relayed to the CoAS via one of our APIs, and
      ii. Stored in a database associated with the CoAS
   b. our biometric scanner installed at the user's facility to scan their retina/fingerprint/etc. The biometric scanner sends this information to our servers with the user's phone number or other installation specific identifier—this information is stored in a database associated with the CoAS.
4. Our portal looks for the user's phone number in the database and locates the relevant information with which to communicate with the user (phone platform type and version, identifier, etc). This information is based on the data received from the user (phone number, device identifier, push token, mobile platform type, mobile platform version, user's language, client version, etc.) as part of the registration flow.
5. Optional: the representative receives from our widget/portal/service app a verification code
6. Our portal sends a secure notification (meaning that the notifications cannot be forged or sent by another party), e.g. using the user's push token, to the user's device containing:
   a. SomeCorp's name
   b. The verification code form item #5 above (optional)
   c. The representative's name (optional)
   d. The textual message entered by the representative (optional)
   e. The country where SomeCorp is registered (optional)
7. Optional: the user may ask the representative for the verification code

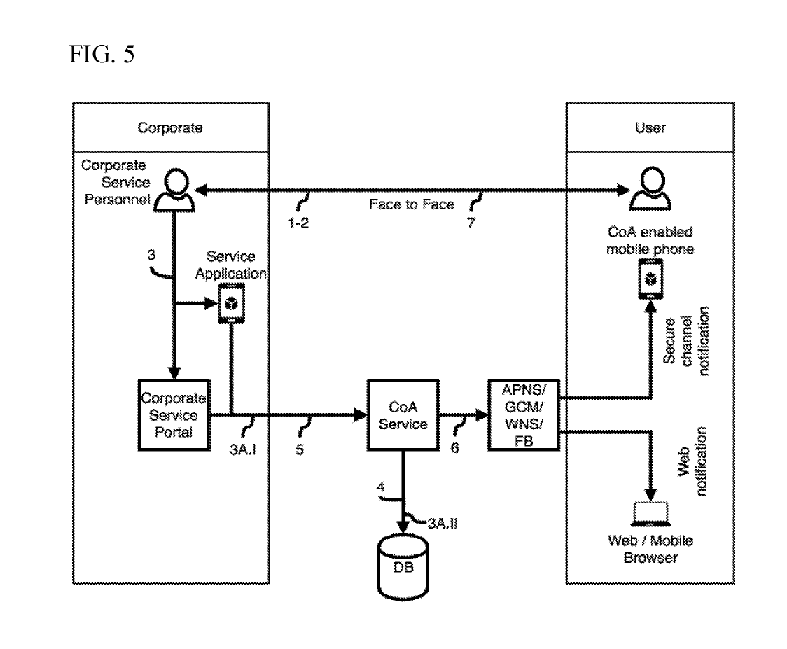

FIG. 5 depicts the various components and connections in use by the Confirmation of Authenticity (CoA) Home Service flow according to an embodiment of the solution:

Web Site Flow May Include Some or all of the Following Operations, Suitably Ordered e.g. as Shown:
1. User receives incoming call
2. Caller claims to be a representative of SomeCorp
3. User asks the representative to provide CoA using our service
4. The representative uses our widget/portal/service app to enter the user's phone number and (optionally) a textual message (e.g. “This is Dan from SomeCorp—I'd like to arrange a technician house call to service our equipment”)—this information is:
   a. Relayed to the CoAS via one of our APIs, and
   b. Stored in a database associated with the CoAS
5. The user goes to SomeCorp's website and using our widget on the site enters his phone number. This information is relayed to the CoAS via one of our APIs.
6. Our portal looks for the user's phone number in the database and locates the relevant information with which to communicate with the user (phone platform type and version, identifier, etc). This information is based on the data received from the user (phone number, device identifier, push token, mobile platform type, mobile platform version, user's language, client version, etc.) as part of the registration flow.
7. Our portal sends a secure notification (meaning that the notifications cannot be forged or sent by another party), e.g. using the user's push token, to the user's device containing:
   a. SomeCorp's name
   b. The representative's name (optional)
   c. The textual message entered by the representative (optional)
   d. The country where SomeCorp is registered (optional)

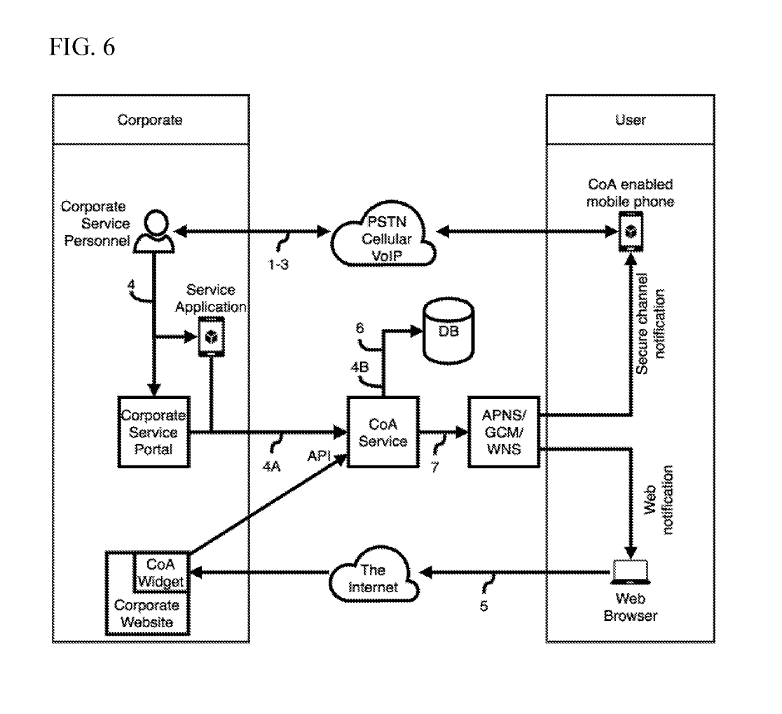

FIG. 6 depicts the various components and connections in use by the Confirmation of Authenticity (CoA) Web Site flow according to an embodiment of the solution:

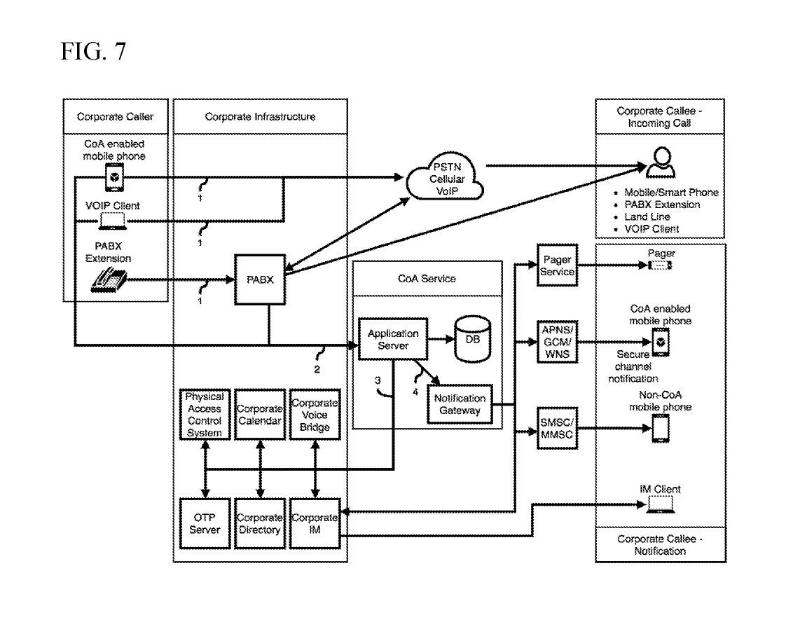

Flow for Automatically Sending a CoA (Triggered by a Corporate User Call) e.g. with Reference to FIG. 7:
1. Corporate user makes a call from one of:
   a. his CoA service-enabled mobile phone (e.g. a mobile phone with one of the following, having CoA functionality: smartphone application; smartphone SDK; HW component; STK application; native application; etc).
   b. the corporate's CoA service-enabled PABX extension (a PABX that is configured to work with the CoA server, e.g. by making a request to a pre-configured URL whenever an outgoing call is made from any of its extensions, by installation of a CoA service software plugin, etc.).
   c. a CoA service-enabled VOIP client (a client that is configured to work with the CoA server, e.g. by making a request to a pre-configured URL whenever an outgoing call is made).
2. The CoA service component/PABX/VOIP client informs the CoA server of the dialed phone number.
3. The server then creates a list of actual destination phones (ADL):
   a. The Actual Destination List (ADL) is initialized as an empty list.
   b. If the original destination number is found to belong to a corporate voice conference (e.g. by integration with a conference call provider/server) the list of participants of this conference is retrieved (from the conference call provider/server) and added to the ADL.
   c. Otherwise the original destination number is added to the ADL as-is.
4. Each number in the ADL is then checked by the server:
   a. The server looks for the number in the database and locates the relevant information with which to communicate with the called user (phone platform type and version, identifier, preferred notification channel, supported notification channels, etc.)
   b. If the phone number is found to belong to a corporate user our portal sends a secure notification to that user's device containing:
      i. SomeCorp's name
      ii. The caller's name
      iii. Any additional information required for the selected notification channel—see Flow for Determining Notification Channel to Use for CoA Sending described herein.

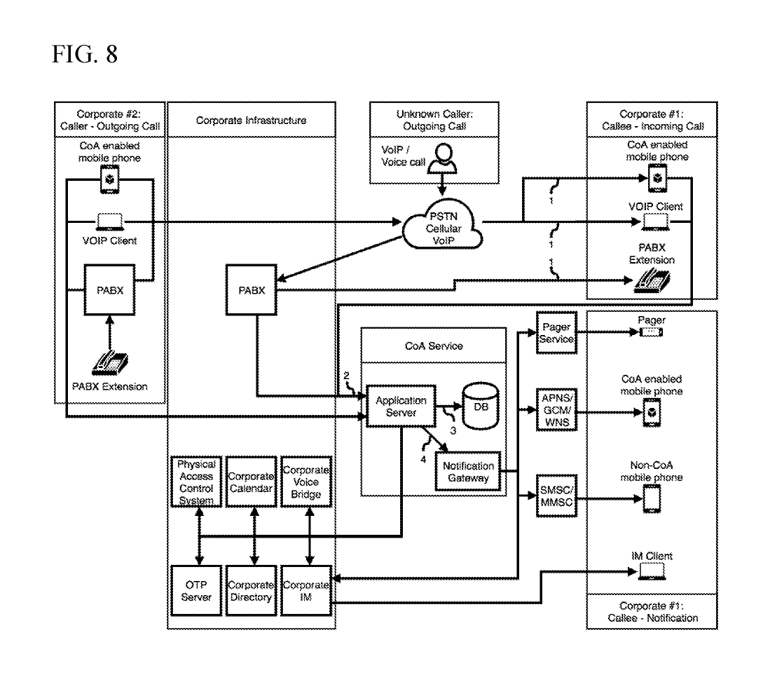

Flow for Validating Inter-Corporate Incoming Call e.g. with Reference to FIG. 8:
1. Corporate user receives a call via one of:
   a. his CoA-enabled mobile phone (a mobile phone with one of the following, having CoA functionality: smartphone application; smartphone SDK; HW component; STK application; native application; etc).
   b. the corporate's CoA service-enabled PABX extension (a PABX that is configured to work with the CoA server, e.g. by making a request to a pre-configured URL whenever an incoming call is made to any of its extensions, by installation of a CoA service software plugin, etc.).
   c. a CoA service-enabled VOIP client (a client that is configured to work with the CoA server, e.g. by making a request to a pre-configured URL whenever an incoming call is received).
2. The CoA service component/PABX/VOIP client informs the CoA server of the received caller-ID information.
3. The server then determines the veracity of the claimed caller-ID by checking whether a call was actually made from the claimed phone number:
   a. If the phone number is assigned to any of CoA service's users and a call was not made from it (information which is available via the Flow for Automatically Sending a CoA (Triggered by a Corporate User Call described herein) the server will set the call's status to fake.
   b. If the phone number is assigned to any of CoA service's users and a call was made from it (information which is available via the Flow for Automatically Sending a CoA (Triggered by a Corporate User Call described herein the server will set the call's status to legitimate.
   c. If the phone number is not assigned to any of CoA service's users the server will set the call's status to unknown.
4. The server will then report the call's status to the called user:
   a. The server looks for the user in the database and locates the relevant information with which to communicate with the called user (phone platform type and version, identifier, preferred notification channel, supported notification channels, etc.)
   b. The server then sends a secure notification to that user's device containing:
      i. The call's status (one of: fake, legitimate, unknown)
      ii. If the call is legitimate: The caller's name and corporate affiliation.
      iii. Any additional information required for the selected notification channel—see Flow for Determining Notification Channel to Use for CoA Sending described herein.

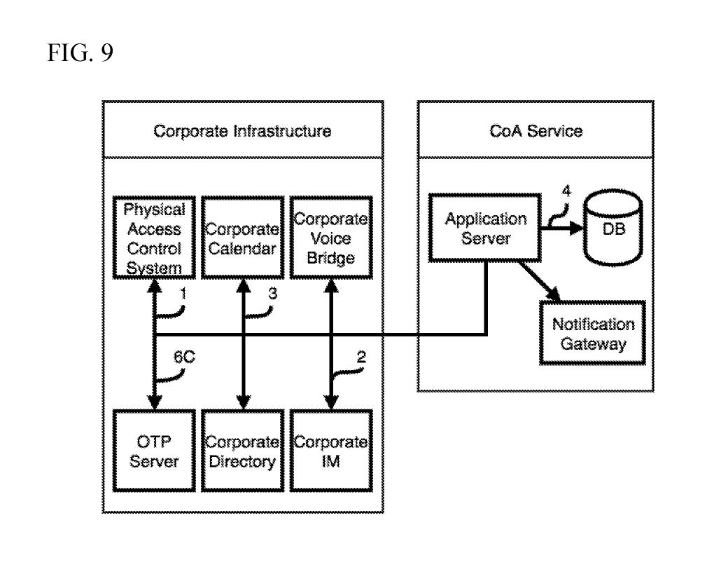

Flow for Determining Notification Channel to Use for CoA Sending e.g. with Reference to FIG. 9

When the CoAS needs to determine which notification channel to use to send a CoA to a user's device it goes through some or all of the following operations:
1. If a Physical Access Control System is integrated with the system: check if the user is in the building.
   a. If the user is not in the building: prefer mobile based notification channels.
2. If a Corporate IM System is integrated with the system: use the IM's presence information:
   a. If the user's status is marked as “Not Available” (or a similar status): prefer mobile based notification channels.
   b. If the user's status is marked as “Do Not Disturb” (or a similar status): reject desktop based notification channels.
3. If a Corporate Calendar System is integrated with the system: use the user's calendar information to determine if the user is currently attending a meeting.
   a. If the user is attending a meeting: prefer mobile based notification channels.
4. Check user settings for preferred notification channel.
   a. If the user has set one or more preferred notification channels, for each such channel:
      i. If the notification channel has not yet been rejected by previous operations—prefer it.
      ii. If the user has set the notification channel as mandatory, prefer it even if it has been rejected by previous operations.
5. Select the notification channel to use—make a list of all known notification channels, ordered according to the specific organization's configuration and then:
   a. Remove from the list all notification channels that have been rejected by previous operations.
   b. Remove from the list all notification channels that are not supported for this user according to the user's registration information.
   c. If previous operations have yielded a preferred notification channel and it is still in the list—select it.
   d. If previous operations have yielded a set of preferred notification channels and any of them are still in the list—select the first such notification channel in the list.
   e. Otherwise select the first notification channel in the list.
6. Handle additional information as dictated by the selected notification channel (this flow may also be applied to other flows described herein.
   a. If the selected notification channel requires a personalized pass-phrase (provisioned by the user via a client or by the corporate IT personnel):
      i. The server uses the previously retrieved user settings and includes the user's pass-phrase in the CoA.
   b. If the selected notification channel requires a personalized image (provisioned by the user via a client or by the corporate IT personnel):
      i. The server uses the previously retrieved user settings and includes the user's personalized image in the CoA.
   c. If the selected notification channel requires a time-synchronized OTP:
      i. The server retrieves an OTP from the corporate OTP server which is in turn included in the CoA.
   d. If the selected notification channel requires a server-based personalized voice signature (provisioned by the user via a client or by the corporate IT personnel):
      i. The server uses the previously retrieved user settings and includes the user's personalized voice-signature in the CoA.
   e. If the selected notification channel requires a client-based personalized voice signature (provisioned by the user via a client):
      i. The CoA service client plays the voice signature when the notification is received.

Many Technological variations are possible, such as but not limited to various technologies for triggering the sending of a Confirmation of Authenticity (CoA).

Representatives may for example use any of the following to send a CoA to users:
our web portal
our widget (using SSO) on their internal service portal
their internal service portal (via an API)
a dedicated service application on their smartphone

The system may use any of the following triggers to automatically send a CoA to users:
a phone call made from a mobile phone on which our smartphone application is installed, on operating systems that support monitoring outgoing calls.
a phone call made from a mobile phone on which an application is installed which has our smartphone SDK integrated, on operating systems that support monitoring outgoing calls.
a phone call made from a mobile phone with a SIM card on which our STK application is installed, with the Call Control service enabled.
a phone call made from a mobile phone which has our HW component installed on it.
a phone call made from a mobile phone which has our native app installed on it.
a phone call made from a VOIP client which is integrated with our server (e.g. by making a request to a pre-configured URL whenever an outgoing call is made)
a phone call made from a corporate phone extension connected to a PABX that is configured to work with our server (e.g. by making a request to a pre-configured URL whenever an outgoing call is made from its extensions, by installation of a CoA service software plugin, etc.)

The system may use any of the following triggers to validate incoming calls made to its users:
a phone call made to a mobile phone on which the HM smartphone application is installed, on operating systems that support monitoring incoming calls.
a phone call made to a mobile phone on which an application is installed which has the HM smartphone SDK integrated, on operating systems that support monitoring incoming calls.
a phone call made to a mobile phone with a SIM card on which our STK application is installed, with the Call Control service enabled.
a phone call made to a mobile phone which has the HM HW component installed on it.
a phone call made to a mobile phone which has our native app installed on it.
a phone call made to a VOIP client which is integrated with the ML server (e.g. by making a request to a pre-configured URL whenever an incoming call is made)
a phone call made to a corporate phone extension connected to a PABX that is configured to work with the HM server (e.g. by making a request to a pre-configured URL whenever an incoming call is made to its extensions, by installation of a CoA service software plugin, etc.)

End-Users may use any of the following to request a CoA:
our widget on a corporation's website
a browser extension
a smartphone application
a smartphone application with an SDK
an STK application installed on the SIM card
a native application on their mobile phone
a biometric scanner installed at the user's facility

The user may for example use any of the following to securely receive CoA (Confirmation of Authenticity) from our service:
a smartphone application via which secure push notifications may be received from our service
a smartphone application with an SDK via which secure push notifications may be received from our service
an STK application installed on the SIM card to receive encrypted notifications from our service
an integrated hardware component on their mobile phone to receive encrypted notifications from our service
a mobile phone which receives a secure identification of the caller via the mobile network's underlying protocols (e.g. GSM's CNAM)
a desktop instant messaging application in use by the corporation
an SMS with any combination (or none) of:
   a personalized textual pass-phrase
   a time-synchronized OTP
a flash SMS with any combination (or none) of:
   a personalized textual pass-phrase
   a time-synchronized OTP
an MIMS with any combination (or none) of:
   a personalized textual pass-phrase
   a time-synchronized OTP
   a personalized image
a pager service with any combination (or none) of:
   a time-synchronized OTP
   a personalized textual pass-phrase
a smartphone application via which secure push notifications may be received from our service accompanied by any combination (or none) of:
   a (client-based or server-based) personalized voice signature
   a personalized textual pass-phrase
   a time-synchronized OTP
   a personalized image
a smartphone application with our SDK via which secure push notifications may be received from our service accompanied by any combination (or none) of:
   a (client-based or server-based) personalized voice signature
   a personalized textual pass-phrase
   a time-synchronized OTP
   a personalized image
an integrated hardware component on their mobile phone to receive encrypted notifications from our service accompanied by any combination (or none) of:
   a (client-based or server-based) personalized voice signature
   a personalized textual pass-phrase
   a time-synchronized OTP
   a personalized image
a web browser connected to a web service (e.g. Facebook) through which secure notifications may be received
a 3rd party smartphone application (e.g. the Facebook smartphone application) via which secure push notifications may be received

The CoAS may rely on several mechanisms to determine which notification channel to use to send a CoA to the user, some of which are:
Corporate IM/Presence Information System—the CoAS may use presence information and/or send CoA to users' desktop IM application via such protocols as XMPP, IRC, PSYC, SIMPLE, other public or proprietary protocols.
Physical Access Control System (PACS/PIAM)—the CoAS may use access control information via such protocols as oBIX, Active Directory®/LDAP, other public or proprietary protocols.
Corporate Calendar System—the CoAS may use calendar information via such protocols as Calendar Access Protocol (CAP), Web Calendar Access Protocol (WCAP), CalDAV, GroupDAV, Scheduling OSID, other public or proprietary protocols.
Corporate Directory—the CoAS may collect user settings information via such protocols as Active Directory®/LDAP, other public or proprietary protocols.

The flows for FIGS. 7-9 may include all or any suitable subset of the operations set out above, suitably ordered e.g. as set out above.

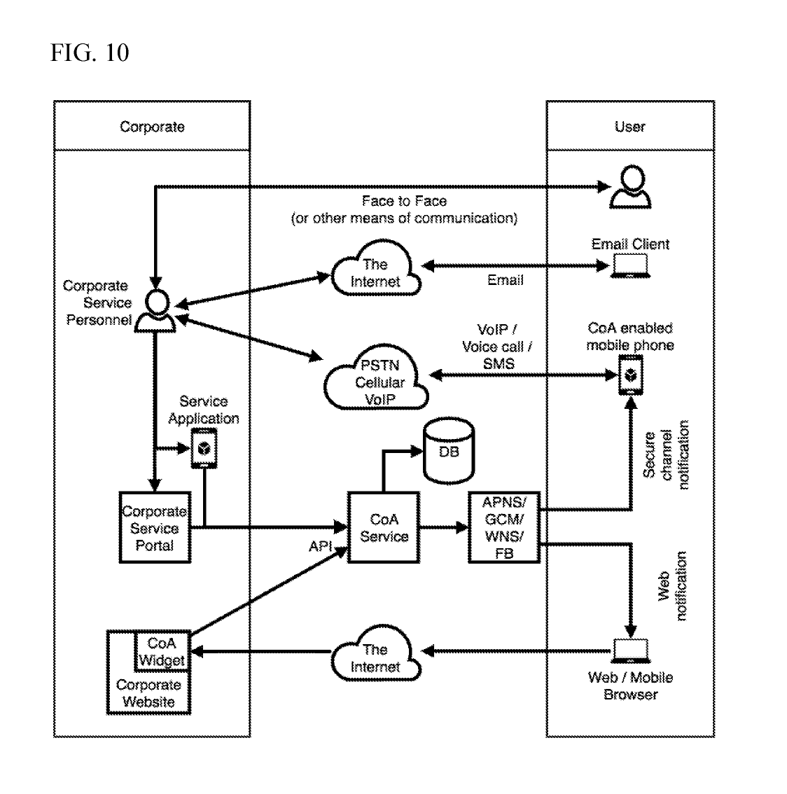

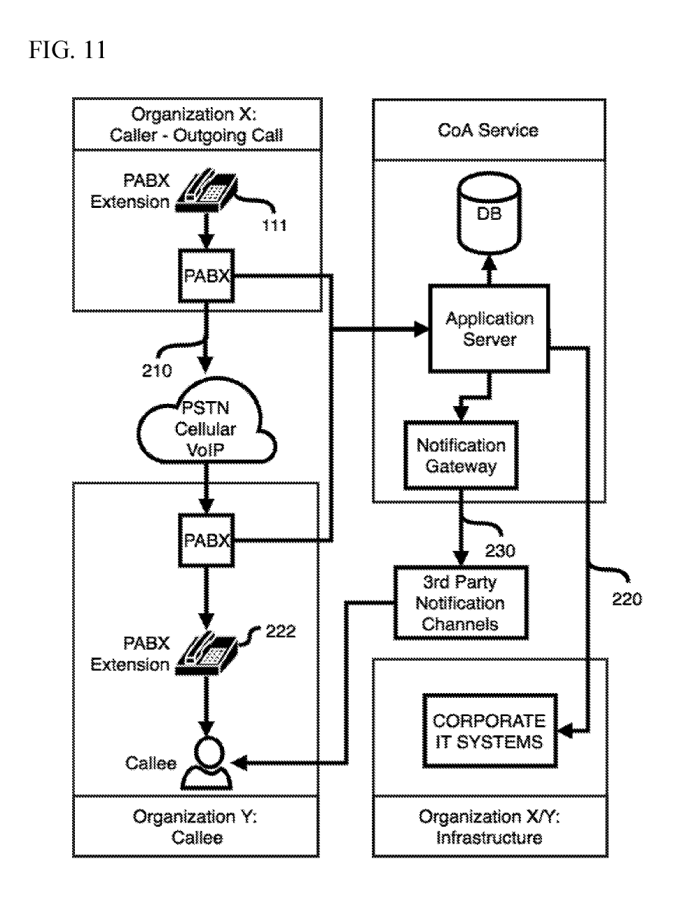

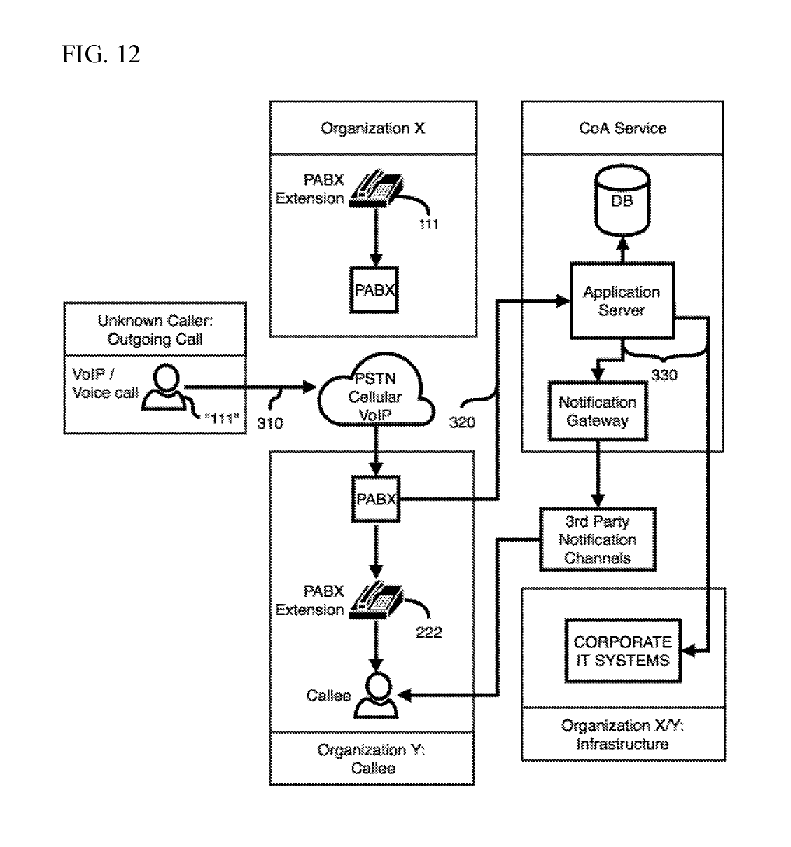

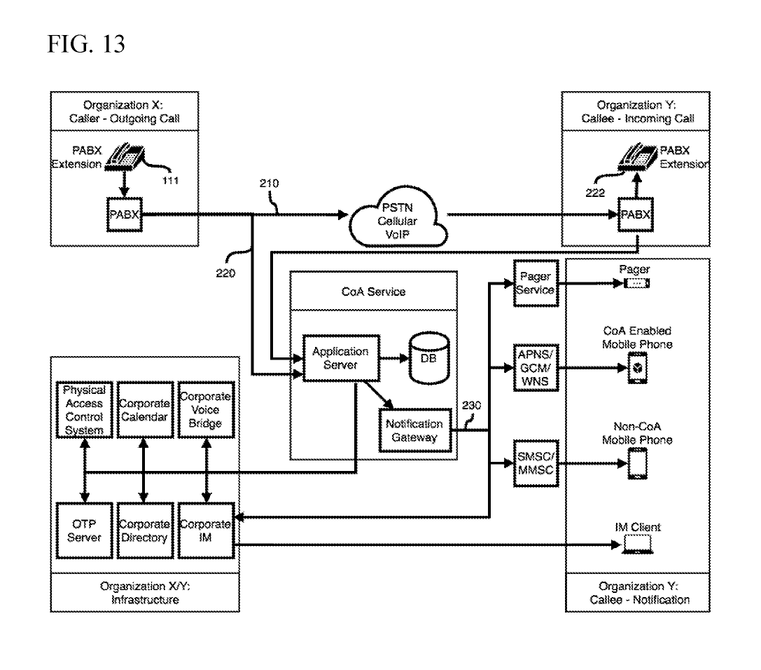

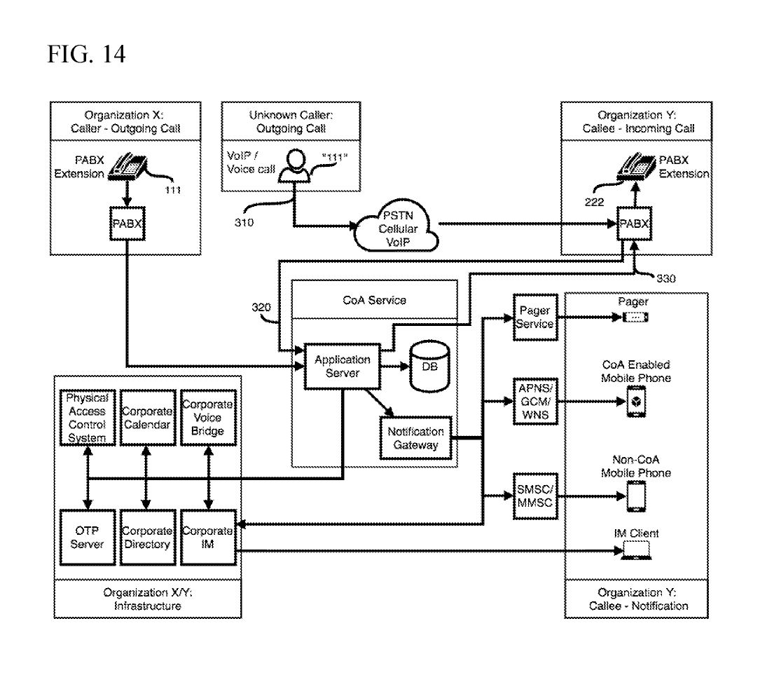

FIG. 10 depicts components and connections some or all of which may be in use by the Confirmation of Authenticity (CoA) flows according to an embodiment of the solution.

Issuing a CoA

The system may issue a CoA to organizations (e.g. private and government entities) that satisfy the requirements e.g. some or all of those specified below. Typically, a vetting process will verify the applicant's legal existence and identity. The validation process is extensive and rigorous to ensure that our CoA will only be awarded to trustworthy and non-fraudulent entities.

Application Process

An entity which wishes to register with our service to become a certified entity may be prompted to submit an application form through our web site. The form may elicit suitable data e.g. some or all of the following information:
1. Organization Name
2. Business Category (private organization, government entity)
3. Jurisdiction of Incorporation/Registration
4. Registration Number
5. Physical Address of Place of Business
6. Main Phone number
7. Domain Name (optional)
8. Contact Information
   a. Fax Number
   b. Email Address
   c. Name of Legal Contact
9. Copy of Certificate of Incorporation/Registration

A confirmation email may automatically be sent to the applicant, stating that the request has been received and is being processed.

Vetting Process

The system typically does not rely on any kind of self-reported data (such as address and phone numbers) during the validation process. All data provided by an applicant hoping to obtain our CoA is typically checked against reliable third-party sources, e.g. using some or all of the processes specified below.

Legal Existence and Identity

Check to make sure that the applicant is legally recognized and that the formal name matches the official government records. In cases where a trading name is used, verify any alternative names that differ from the legal name of the applicant in qualified databases.
For Private Organizations this will be verified with, or obtained directly from, the incorporating or registration agency in the applicant's jurisdiction of incorporation or registration. We will also verify that the entity is not designated on the records of the incorporating or registration agency by labels such as “inactive”, “invalid”, “not current”, or the equivalent;
For Government Entities this will be verified directly with, or obtained directly from, one of the following:
   a qualified government information source in the political subdivision in which such government entity operates;
   a superior governing government entity in the same political subdivision as the applicant, or
   from a judge that is an active member of the federal, state or local judiciary within that political subdivision, or
   an attorney representing the government entity.

Physical Existence

Cross-check the address listed in the application against a qualified government database. If the listed address cannot be verified by consulting the government database, an on-site visit may be necessary to investigate the discrepancy. Investigators may need to take photos of the facility and business operations or speak with company personnel.

Operational Existence

To verify the applicant's operational existence:
1. Verify that the applicant has an active current Demand Deposit Account with a regulated financial institution. We will only accept authenticated documentation directly from a regulated financial institution verifying that the applicant has an active current Demand Deposit Account with the institution; and/or
2. Rely on a verified legal opinion or a verified accountant letter to the effect that the applicant has an active current Demand Deposit Account with a regulated financial institution.

Telephone Number

Confirm that the telephone number listed on the application is the primary telephone number for the requesting organization. This is accomplished by calling the number directly and by checking phone directory listings.

Domain Name (Optional)

An applicant wishing to obtain a CoA for use with our widget on their website or through our browser extension must own and control the relevant domain name. We will check website registration records (Whois database) or we may ask the applicant to make a change to the website under the domain name.

Individual's Authorization

Verify that the individual applying for the CoA is acting as a legitimate agent for the applicant. Verify the identity of the contract signer (in most cases this will be a C-level management person). Usually this is verified with written documentation.

One way that we may verify this data is by contacting the applicant's human resources department. We may additionally require a face-to-face validation in which the individual must present the following documentation directly:
A personal statement that includes some or all of the following information:
   Full name or names by which a person is, or has been, known (including all other names used);
   Residential Address at which he/she can be located;
   Date of birth; and
   An affirmation that all of the information contained in the application is true and correct.
A current signed government-issued identification document that includes a photo of the Individual and is signed by the Individual.
At least two secondary documentary evidences to establish his/her identity that include the name of the individual, one of which must be from a financial institution.

After the vetting process is complete the entity may be prompted to register each of their representatives in the system via our web portal. For each representative at least the following information is registered:
1. Full name—used to display the name of the representative to the user when the CoAS sends a CoA
2. Username—used by the representative to login to our web portal
3. Password—used by the representative to login to our web portal

Code Verification API

Following is one example of an API that can support the code verification process required in the registration flow.

API requests and responses are transported over HTTP (optionally over HTTPS) using the HTTP GET and POST methods. Reponses are usually represented using JSON.

The server may reply with any of the following response codes:
200 OK—the request was successful (some API calls may return 201 instead).
400 Bad Request—the request could not be understood or was missing required parameters.
403 Forbidden—the server understood the request, but is refusing to fulfill it. Authorization will not help and the request SHOULD NOT be repeated. The server will provide additional information in the header of the response (specifics provided in each relevant case where this may happen).
404 Not Found—resource was not found.
405 Method Not Allowed—requested method is not supported for resource.
500 Server Error—The server encountered an unexpected condition which prevented it from fulfilling the request.

Requests made to the server should include the following HTTP headers:
Device-ID—Unique identifier of the device.
Client-Version—Version number of the client
Client-Language—The current language in use by the client
Device-Model—The device model
Platform—The device platform: iOS, Android, etc.
Platform-Version—The device platform version
Client-Flavor—The client version/skin
User-Secret—The secret provided by the server in the initial phone verification process. Note: This header is mandatory for all requests except for the initial verification requests.
User-ID—The user ID—in this case it's the user's MSISDN. Note: This header is mandatory for all requests except for the initial verification requests.

The API supports the following operations:
Get Verification Code—enables asking for a new verification code for a phone number.
   Request end point: http://www.example.com/v1.0/action/code/{msisdn}/
   Method: GET
   Possible Server Responses:
      200 OK—The server will provide an empty response and will send a text message to the provided phone number with a verification code. The response will also include the length of the code, usually 4-6 characters. Sample response payload:

{

“header”: {

“uri”: “/v1.0/action/code/1555555555”,
“status”: 200,
“code”: “ok.success”,
“message”: “A verification code will be sent to the provided
number”,
“developerMessage”: “A verification code will be sent to the

provided number”,

“moreInfo”: “mailto:support@example.com”

},
“payload”: {

“code”: {

“length”: 4,
“type”: “numeric”

}

}

}

400 Bad Request—The provided ID is not a valid mobile phone number. Sample response payload:

{

“header”: {

“uri”: “/v1.0/action/code/1555555555”,
“status”: 400,
“code”: “error. parameter.illegal”,
“message”: “The provided ID is not a valid mobile phone
number”,
“developerMessage”: “The ID is not a valid mobile phone
number”,
“moreInfo”: “mailto:support@example.com”

},
“payload”: null

}

Confirm Verification Code—Enables confirming a new verification code for a phone number.
   Request end point: http://www.example.com/v1.0/action/code/{msisdn}/
   Method: POST
   Request parameters:
      code—The verification code provided by the user
      push-token—The application's push token
   Sample request structure:

{

“code”: “12345”,
“push-token”: “ABBC12345”

}

Possible Server Responses:
   200 OK—The server will provide a response (containing the user secret to be used in following requests) and will send a text message to the provided phone number with a verification code. Sample response payload:

{

“header”: {

“uri”: “/v1.0/action/code/1555555555”,
“status”: 200,
“code”: “ok.success”,
“message”: “The provided verification code has been verified”,
“developerMessage”: “The provided code has been verified”,
“moreInfo”: “mailto:support@example.com”

},
“payload”: {

“user-secret”:
“ABCDEF1234567890ABCDEF123456789067890”

}

}

403 Forbidden—The provided verification code is incorrect. Sample response payload:

{

“header”: {

“uri”: “/v1.0/action/code/1555555555”,
“status”: 403,
“code”: “error.verification.wrong”,
“message”: “The provided verification code is incorrect”,
“developerMessage”: “The provided verification code is
incorrect”,
“moreInfo”: “mailto:support@example.com”

},
“payload”: null

}

CoA Trigger/Verify API

Following is one example of an API that can support the triggering of sending a CoA to a customer by a representative as described in the CoA flows.

API requests and responses are transported over HTTP (optionally over HTTPS) using the HTTP GET and POST methods. Reponses are usually represented using JSON.

The server may reply with any of the following response codes:
200 OK—the request was successful (some API calls may return 201 instead).
400 Bad Request—the request could not be understood or was missing required parameters.
403 Forbidden—the server understood the request, but is refusing to fulfill it. Authorization will not help and the request SHOULD NOT be repeated. The server will provide additional information in the header of the response (specifics provided in each relevant case where this may happen).
404 Not Found—resource was not found.
405 Method Not Allowed—requested method is not supported for resource.
500 Server Error—The server encountered an unexpected condition which prevented it from fulfilling the request.

The API supports the following operations:
Record Service Transaction—enables a representative to inform the CoAS that a service transaction is taking place with a user for the representative's organization. The representative's organization is identified implicitly by the representative's login credentials. Access to the API is restricted to authenticated users (via our service app or the corporate web portal using SSO) and to trusted IP ranges.
   Request end point: http://www.example.com/v1.0/action/service/{msisdn}/
   Method: POST
   Request parameters:
      message—An optional text message to be sent to the user alongside the CoA
   Sample request structure:

{

“message”: “This is Dan from SomeCorp - I'd like to arrange a

technician house call to service our equipment”
}

Possible Server Responses:
   200 OK—The server will optionally provide a verification code and may send a secure notification to the user.

{

“header”: {

“uri”: “/v1.0/action/service/1555555555”,
“status”: 200,
“code”: “ok.success”,
“message”: “A CoA will be sent to the provided number”,
“developerMessage”: “A CoA will be sent to the provided
number”,
“moreInfo” : “mailto:support@example.com”

},
“payload”: {

“code”: “112312”

}

}

400 Bad Request—The provided ID is not a valid mobile phone number. Sample response payload:

{

“header”: {

“uri”: “/v1.0/action/service/1555555555”,
“status”: 400,
“code”: “error.parameter.illegal”,
“message”: “The provided ID is not a valid mobile phone
number”,
“developerMessage”: “The ID is not a valid mobile phone
number”,
“moreInfo”: “mailto:support@example.com”
},

“payload”: null

}

Confirm Service Transaction—Enables confirming the existence of a service transaction for a phone number for a specific organization (this is used in the CoA Web Flow). The organization is identified implicitly by the widget through which the request is made (requests are made via our widget on the organization's web portal).
   Request end point: http://www.example.com/v1.0/action/code/{msisdn}/
   Method: GET
   Possible Server Responses:
      200 OK—The server will provide a indicating that a service transaction has indeed been recorded for this phone number from the relevant organization. Sample response payload:

{

“header”: {

“uri”: “/v1.0/action/code/1555555555”,
“status”: 200,
“code”: “ok.success”,
“message”: “ A service transaction has been recorded for the

provided phone number 5 minutes ago ”,

“developerMessage”: “ A service transaction has been recorded

for the provided phone number 5 minutes ago”,

“moreInfo”: “mailto:support@example.com”

},
“payload”: null

}

400 Bad Request—The provided ID is not a valid mobile phone number. Sample response payload:

{

“header”: {

“uri”: “/v1.0/action/service/1555555555”,
“status”: 400,
“code”: “error.parameter.illegal”,
“message”: “The provided ID is not a valid mobile phone
number”,
“developerMessage”: “The ID is not a valid mobile phone
number”,
“moreInfo”: “mailto:support@example.com”

},
“payload”: null

}

404 Not Found—No service transaction has been recorded for the provided phone number in the last XX minutes (XX is a configurable value). Sample response payload:

{

“header”: {

“uri”: “/v1.0/action/service/1555555555”,
“status”: 404,
“code”: “ error.resource.not-found”,
“message”: “No service transaction has been recorded for the

provided phone number”,

“developerMessage”: “No service transaction has been recorded

for the provided phone number ”,

“moreInfo”: “mailto:support@example.com”

},
“payload”: null

}

An example integration procedure that an integrator might perform when s/he integrates or registers organization x, e.g. preparatory to performing the methods of Flowcharts 1, 2 above, is now described (it is appreciated that when each new organization is registered the operations performed may depend on requirements defined for that specific organization). Some or all of the following operations may be performed:
1. User Management
   a. Determine how the organization's user information is to be managed, one of:
      i. Use the organization's directory
         1. In this case the organization's corporate directory is used to hold all the information that is required pertaining to the users (phone numbers, names, prefered notification methods, personalized PIN code, etc).
         2. This requires integration of the system with the organization's corporate directory with read-write access.
      ii. Use the CoAS's own user database
         1. In this case the system uses its internal database to hold all the information it needs pertaining to the users (phone numbers, names, prefered notification methods, personalized PIN code, etc).
         2. This requires either manual (via the CoAS command line interface web interface) or batch provisioning (via the CoAS command line interface or web interface) of this information as received from the organization.
      iii. Use both
         1. In this case the system uses:
         a. Its internal database to hold all of the proprietary information pertaining to the users (prefered notification methods, personalized PIN code, etc).
         b. The organization's corporate directory to hold all of the corporate information pertaining to the users (phone numbers, names, etc).
         2. In this case the system may be integrated with the organization's corporate directory with read-only access.
         3. Additionally this requires either manual (via the CoAS command line interface web interface) or batch provisioning (via the CoAS command line interface or web interface) of the proprietary information as received from the organization.
2. Notification Method Selection
   a. Determine whether presence information is to be used to determine which notification method to use. If so integrate the system with the organization's presence server.
   b. Determine whether calendar information is to be used to determine which notification method to use. If so—integrate the system with the organization's corporate calendar server.
   c. Determine whether physical presence information it to be used to determine which notification method to use. If so—integrate the system with the organization's PACS system.
   d. Determine which notification methods need to be supported:
      i. If Instant Messaging is to be used as a notification method integrate the system with the organization's IM system.
      ii. If Smartphone Push Notifications are to be used as a notification method via the organization's smartphone application or via the smartphone SDK request the organization to provide push certificates for all relevant platforms (APNS, GCM, etc) and add them to the system configuration.
      iii. If time-synchronized OTPs are to be used as part of the notifications sent to users integrate the system with the organization's OTP server.
      iv. For all other notification methods (SMS, MIMS, Flash SMS, etc.)—if any of them need to be supported enable them accordingly on the CoAS for this organization.
3. Call Validation
   a. Determine whether call information is to be retrieved from the corporate PABX. If so—integrate the system with the PABX.
   b. Determine whether call information is to be retrieved from the corporate VOIP clients. If so—integrate the system with the VOIP clients.
   c. Determine whether call information is to be retrieved via the corporate smartphone application. If so—provide the SDK to the organization and provision an API key for this organization on the CoAS. This API key uniquely identifies requests made to the CoAS server as belonging to this organization.
   d. Determine whether call information is to be retrieved via a voice conference/bridge system. If so—integrate the system with the voice conference server.

### EXAMPLE

It is appreciated that the specific implementation of certain embodiments may be protocol-specific.

The following example assumes that the CoAS sends CoA to users' desktop Instant Messaging (IM) applications via via the XMPP protocol. Other implementations may be developed mutatis mutandis, for other protocols.

1. Corporate Instant Messaging System

The CoAS may send CoA to users' desktop Instant Messaging (IM) applications via such protocols as XMPP. In order to send messages via the XMPP protocol some or all of the following operations may to be performed.

1.1. Basic Integration

When the CoAS is first integrated a dedicated user may be assigned to the CoAS for communication with the XMPP platform.

1.2. Per-User Configuration

When a new corporate user is added to the corporate systems the CoAS will generate a “subscription request” (a request from a user for authorization to permanently subscribe to a contact's presence information). Such requests will be of the form:
<presence id=‘xk3hlv69’ to=‘juliet@example.com’ type=‘subscribe’/>

These subscription requests may be approved in one of two modes:
Before the subscription request is sent (pre-approval):
   Manually via the user's XMPP client application (on the user's desktop computer or mobile phone) using pre-approval. Such messages will be of the form:

<presence id=‘pg81vx64’ to=‘identity_authentication@example.com’
type=‘subscribed’/>

After the subscription request is sent:
   Either automatically by the user's XMPP server if so configured by the corporate's IT personnel. Such messages will be of the form:

<presence from =‘juliet@example.com’ id=‘xk3h1v69’
to=‘identity_authentication@example.com’ type=‘subscribed’/>

Or manually via the user's XMPP client application (on the user's desktop computer or mobile phone). Such messages will be of the form:

<presence id=‘h4v1c4kj’ to=‘identity_authentication@example.com’
type=‘subscribed’/>

1.3. Data Exchange

When the need arises to send a CoA to a user via IM, the CoAS initiates a One-to-One session with the user with a type attribute of ‘headline’ (to indicate that the message provides an alert/notification to which no reply is expected) by sending a message of the form:

<message from =‘identity_authentication@example.com’ id=‘b4vs9km4’
to=‘romeo@example.net’ type=‘headline’ xml:lang=‘en’>

<body>Warning: fake caller!</body>

</message>

2. Corporate Presence Information System Example

The CoAS may use presence information via such protocols as XMPP. In order to gather presence information via the XMPP protocol some or all of the following operations may be performed.

2.1. Basic Integration

When the CoAS is first integrated a dedicated user may be assigned to the CoAS for communication with the XMPP platform.

2.2. Per-User Configuration

When a new corporate user is added to the corporate systems the CoAS will generate a “subscription request” (a request from a user for authorization to permanently subscribe to a contact's presence information). This will enable the CoAS to retrieve the presence information for the user. Such requests will be of the form:
<presence id=‘xk3hlv69’ to=‘juliet@example.com’ type=‘subscribe’/>

These subscription requests may be approved in one of two modes:
Before the subscription request is sent (pre-approval)
   Manually via the user's XMPP client application (on the user's desktop computer or mobile phone) using pre-approval. Such messages will be of the form:

<presence id=‘pg81vx64’ to=‘identity_authentication@example.com’
type=‘subscribed’/>

After the subscription request is ent
   Either automatically by the user's XMPP server if so configured by the corporate's IT personnel. Such messages will be of the form:

<presence from=‘juliet@example.com’ id=‘xk3h1v69’
to=‘identityauthentication@example.com’ type=‘subscribed’/>

Or manually via the user's XMPP client application (on the user's desktop computer or mobile phone). Such messages will be of the form:

<presence id=‘h4v1c4kj’ to=‘identity_authentication@example.com’
type=‘subscribed’/>

2.3. Data Exchange

When the need arises to retrieve a user's presence the CoAS generates a presence probe request, such as the following:

<presence from=‘identity_authentication@example.com’ id=‘ign291v5’
to=‘romeo@example.net’ type=‘probe’/>

The presence information is then returned to the CoAS—such information may of the form:

<presence from=‘romeo@example.net/bar’ id=‘ps6t1fu3’
to=‘identity_authentication@example.com’>

<show>away</show>

</presence>

3. Physical Access Control System (PACS/PIAM)

The CoAS may use Physical Access Control System information in order to detect whether a user is currently on premises or not. In order to gather such information via the LDAP protocol the operations described in the “Corporate Directory” section herein, may be performed.

4. Corporate Calendar System

The CoAS may use calendar information via such protocols as CalDAV. This is usually done in order to determine whether a user is currently busy (in a meeting) or not. In order to gather such information via the CalDAV protocol some or all of the following operations may be performed.

4.1. Basic Integration

When the CoAS is first integrated a dedicated user may be assigned to the CoAS for communication with the calendar server.

The CALDAV:read-free-busy privilege should be granted on calendar collections, regular collections, and calendar object resources.

4.2. Per-User Configuration

In order for the CoAS to access the correct calendar information for the user one of several approaches may be performed:
1. The calendar server may be configured to allow multiple alias URLs for each CalDAV-compliant resource. Specifically, if user calendar information is usually accessible via the user's corporate email address (e.g. /bernard@corp.com/work/) or other corporate identifier (e.g. /bernard11/work/), the server may be configured to allow access to the same resource via the user's phone number (e.g. /1555555555/work/).
2. The CoAS may be integrated with the corporate directory (e.g. via LDAP) to retrieve the URL or identifier via which to retrieve the user's calendar information. See Corporate Directory for operations to integrate with the corporate directory.

4.3. Data Exchange

When the need arises to retrieve a user's free/busy information the CoAS generates a free-busy-query report for the current timestamp, such as the following:

REPORT /bernard/work/ HTTP/1.1
Host: cal.example.com
Depth: 1
Content-Type: application/xml; charset=“utf-8”
Content-Length: 184
<?xml version =“1.0” encoding=“utf-8” ? >
<C:free-busy-query xmlns:C=“urn:ietf:params:xml:ns:caldav”>

<C:time-range start=“20150104T140000Z”

end=“20150104T140100Z”/>

</C:free-busy-query>

The free/busy information is then returned to the CoAS—such information may be of the form:

HTTP/1.1 200 OK
Date: Sat, 11 Nov 2006 09:32:12 GMT
Content-Type: text/calendar
Content-Length: 231
BEGIN:VCALENDAR
VERSION:2.0
PRODID:-//Example Corp.//CalDAV Server//EN
BEGIN:VFREEBUSY
DTSTAMP:20150103T110000Z
DTSTART:20150104T140000Z
DTEND:20150104T140100Z
FREEBUSY;FBTYPE=BUSY:20150104T140000Z/PT1H
END:VFREEBUSY
END:VCALENDAR

5. Corporate Directory

The CoAS may retrieve a user's settings and information from the corporate directory via such protocols as LDAP. In order to gather such information via the LDAP protocol some or all of the following operations may be performed.

5.1. Basic Integration

When the CoAS is first integrated a dedicated user may be assigned to the CoAS for communication with the corporate directory.

In addition certain parameters (e.g. Base DN, specific LDAP schema attribute names) may be provided by the corporate IT department so that the CoAS can successfully search for user information in the corporate directory.

5.2. Per-User Configuration

The CoAS user should have at least read-only access to the information of all corporate users for which the service is to be enabled.

5.3. Data Exchange

When the need arises to retrieve a user's information the CoAS queries this information from the corporate directory via the LDAP protocol, using some or all of the following operations:
1. Initialize a Session (e.g. using ldap_init( ))—Sets the default session option settings in the LDAP structure. The LDAP session state is stored in the LDAP structure. The session options can be read or set prior to binding.
2. Connect to the Server (e.g. using ldap_connect( ))—Establishes an LDAP connection to the LDAP server.
3. Bind to the server (e.g. using ldap_simple_bind_s( ))—The LDAP server authenticates the client.
4. Search the directory for the required user (e.g. using ldap_search_ext_s( )). Usually this operation would be done using some or all of the following search parameters:
   a. base: the Base DN as provided by the corporate IT department. Usually of the form:
      dn=“dc=example;dc=com”
   b. scope:
      LDAP_SCOPE_SUBTREE
   c. filter: depending on the specific scheme used by the corporate IT department. Some common examples:
      (mobile=+1-5555555555)
      (ipPhone=+15555555556)
      (telephoneNumber=+15555555557)
   d. attrs: usually all attributes should be returned which is done using the value:
      NULL
5. Close the connection to the LDAP server when finished (e.g. using ldap_unbind( )).

The information returned by the server may contain multiple attributes which may be used by the CoAS in the performance of its role. Some examples:
Identifiers
   employeeID—the Employee ID which may be used to access other information sources (e.g. a physical access control system).
Name attributes—can be used when sending CoA to users to identify the calling party.
   givenName
   cn
   displayName
   name
Logon/Logoff times—can be used to determine whether the user is still at work:
   lastLogoff
   lastLogon
   lastLogonTimestamp
Custom attributes
   Public calendar URL—a URL to be used to access the user's calendar information
   IM identifier—the user's ID on the corporate IM platform
   Last entry/exit—can be used to determine whether the user is still on the premises. Such attributes would be set by the corporate Physical Access Control System.

6. Corporate PABX

The CoAS may detect an outgoing or incoming call to a corporate PABX system. This is done by integrating the two platforms. For example, such an integration with the Cisco Unified Call Manager (CUCM) system for this purpose could be done via JTAPI. When using JTAPI, the CoAS serves as a JTAPI client and CUCM acts as the JTAPI server. In this integration scheme the CoAS listens to events and when an outgoing call is detected a notification is sent to the callee according to CoAS's standard notification flow.

6.1. Basic Integration

An application user may be created on CUCM with access to CTI enable. The CoAS then registers as a listener to all JTAPI events.

6.2. Per-User Configuration

The application user may be granted access to all extensions that need to be so monitored.

6.3. Data Exchange
1. When an event is received via JTAPI the CoAS checks to see whether the event is for an incoming or outgoing call via, for example, the CallControlConnection.getCallControlState( ) interface method. The following states, some or all, returned from said method, may be used by the CoAS to determine the status of relevant calls:
   CallControlConnection.OFFERED—This state indicates that an incoming call is being offered to the address associated with the Connection.
   CallControlConnection.NETWORK_REACHED—This state indicates that an outgoing telephone call has reached the network.
2. When a call is detected the CoAS will retrieve some or all of the following information via the CallControlCall interface. This information is then used to determine the validity of the call:
   The calling address, as returned by the CallControlCall.getCallingAddress( ) method is the Address which originally placed the Call.
   The calling terminal, as returned by the CallControlCall.getCallingTerminal( ) method is the Terminal which originally placed the Call.
   The called Address, as returned by the CallControlCall.getCalledAddress( ) method is the Address to which the Call was originally placed.
   The last redirected address, as returned by the CallControlCall.getLastRedirectedAddress( ) method is the Address to which this Call was placed before the current destination Address. For example, if a Call was forwarded from one Address to another, then the first Address is the last redirected Address for this call.
3. In case the call may be disconnected the CoAS will perform the following operation via the CallControlCall interface:
   CallControlCall.drop( )—drops the entire Call.

Any or all of computerized sensors, output devices or displays, processors, data storage and networks may be used as appropriate to implement any of the methods and apparatus shown and described herein.

It is appreciated that terminology such as “mandatory”, “required”, “need” and “must” refer to implementation choices made within the context of a particular implementation or application described herewithin for clarity and are not intended to be limiting since in an alternative implantation, the same elements might be defined as not mandatory and not required or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations as appropriate; machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The system may if desired be implemented as a web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Some or all functionalities e.g. software functionalities shown and described herein may be deployed in a cloud environment. Clients e.g. mobile communication devices such as smartphones may be operatively associated with but external to the cloud.

The scope of the present invention is not limited to structures and functions specifically described herein and is also intended to include devices which have the capacity to yield a structure, or perform a function, described herein, such that even though users of the device may not use the capacity, they are if they so desire able to modify the device to obtain the structure or function.

Features of the present invention, including operations, which are described in the context of separate embodiments may also be provided in combination in a single embodiment. For example, a system embodiment is intended to include a corresponding process embodiment and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly although not limited to those described in the Background section or in publications mentioned therein.

Conversely, features of the invention, including operations, which are described for brevity in the context of a single embodiment or in a certain order may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise some or all of the operations illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting.

1. A system for confirming authenticity of an organizational affiliation claim (claimed organizational affiliation), the system comprising:
A database of organizations;
A server/processor able to access the database; and
a channel of communication to end-users allowing end-users to receive from the processor an authentication of the claimed organizational affiliation.

2. A system according to claim 1 wherein the processor authenticates to a destination associated with an end-user responsive to receiving said destination from a recognized representative of an organization in said database of organizations.

3. A system according to any of the preceding claims wherein the organizational affiliation claim is made via: a telephone call, house visit, or text message.

4. A system according to any of the preceding claims wherein the organizational affiliation claim is made by a claimant who provides an end-user's mobile phone number to a Confirmation of Authenticity Service (CoAS) and responsively, the CoAS sends the user a secure message if the representative is indeed affiliated with the claimed organization.

5. A system according to claim 4 wherein the phone number is provided via at least one of:
1. A dedicated service portal
2. organization portal which communicates with the CoAS via an API
3. dedicated smartphone application

6. A system according to any of the preceding claims wherein a flow including at least some of the following operations is provided:
1. User installs app on their phone
2. User runs app on their phone
3. The app requests the user to enter their phone number
4. The user enters the phone number
5. The app sends a request to the server to validate the phone number
6. The server sends a text message to the given phone number with a verification code
7. The user enters the code from the text message into the app
8. The app sends the code back to the server which determines if it's valid
9. The server responsively records data for the user.

7. A system according to claim 6 wherein said data comprises any subset or all of:
a. Phone number
b. Device Identifier
c. Push token
d. Mobile platform type
e. Mobile platform version
f. User's language
g. Client version

8. A system according to any of the preceding claims wherein a flow including at least some of the following operations is provided:
1. User installs a corporation's app which includes an SDK on their phone
2. User runs the app on their phone
3. The app requests the user to enter their phone number
4. The user enters the phone number
5. The app sends a request to the server via the SDK to validate the phone number
6. The server sends a text message to the given phone number with a verification code
7. The user enters the code from the text message into the app
8. The app sends the code back to the server via the SDK which determines if it's valid
9. The server then records data characterizing the user.

9. A system according to claim 8 wherein the data characterizing the user includes all or any subset of:
a. Phone number
b. Device Identifier
c. Push token
d. Mobile platform type
e. Mobile platform version
f. User's language
g. Client version

10. A system according to any of the preceding claims wherein a flow including at least some of the following operations is provided:
1. User adds a dedicated Facebook app to their Facebook account
2. User runs the Facebook app
3. The app requests the user to enter their phone number
4. The user enters the phone number
5. The app sends a request to the server to validate the phone number (optionally over a secure connection). Responsively validation occurs e.g. as per some or all of operations 6
9 below.
6. The server sends a text message to the given phone number with a verification code.
7. The user enters the code from the text message into the Facebook app.
8. The app sends the code back to the server (optionally over a secure connection) which determines if it's valid and responds to the app accordingly.
9. The server then records data characterizing the user.

11. A system according to claim 10 wherein the data characterizing the user includes all or any subset of:
a. Phone number
b. Facebook User ID
c. User's language
d. App version

12. A system according to any of the preceding claims wherein a Confirmation of Authenticity (CoA) flow is provided.

13. A system according to claim 12 wherein the Confirmation of Authenticity flow includes at least some of the following operations, for phone call presentation of organizational affiliation claim:
1. User receives incoming call
2. Caller claims to be a representative of SomeCorp
3. User asks the representative to provide CoA using our service
4. The representative uses our widget/portal/service app to enter the user's phone number and (optionally) a textual message
5. Our portal looks for the user's phone number in the database and locates the relevant information with which to communicate with the user (phone platform type and version, identifier, etc.)
6. Optional: the representative receives from our widget/portal/service app a verification code
7. Our portal sends a secure notification to the user's device containing:
a. SomeCorp's name
b. The verification code form item #6 above (optional)
c. The representative's name (optional)
d. The textual message entered by the representative (optional)
e. The country where SomeCorp is registered (optional)
8. Optional: the user may ask the representative for the confirmation code

14. A system according to claim 12 wherein the Confirmation of Authenticity flow includes at least some of the following operations, for SMS presentation of organizational affiliation claim:
1. User receives a text message claiming to be from a representative of SomeCorp
2. User asks the representative to provide CoA using our service
3. The representative uses our widget/portal/service app to enter the user's phone number and (optionally) a textual message
4. Our portal looks for the user's phone number in the database and locates the relevant information with which to communicate with the user (phone platform type and version, identifier, etc.)
5. Optional: the representative receives from our widget/portal/service app a verification code
6. Our portal sends a secure notification to the user's device containing:
a. SomeCorp's name
b. The verification code form item #5 above (optional)
c. The representative's name (optional)
d. The textual message entered by the representative (optional)
e. The country where SomeCorp is registered (optional)
7. Optional: the user may ask the representative for the confirmation code

15. A system according to claim 12 wherein the Confirmation of Authenticity flow includes at least some of the following operations, for in-person presentation of organizational affiliation claim:
1. A person claiming to be from a representative of SomeCorp knocks on user's door
2. User asks the representative to provide CoA using our service
3. The representative uses either:
a. our widget/portal/service app to enter the user's phone number and (optionally) a textual message
b. our biometric scanner installed at the user's facility to scan their retina/fingerprint/etc. The biometric scanner sends this information to our servers with the user's phone number or other installation specific identifier.
4. Our portal looks for the user's phone number in the database and locates the relevant information with which to communicate with the user (phone platform type and version, identifier, etc.)
5. Optional: the representative receives from our widget/portal/service app a verification code
6. Our portal sends a secure notification to the user's device containing:
a. SomeCorp's name
b. The verification code form item #5 above (optional)
c. The representative's name (optional)
d. The textual message entered by the representative (optional)
e. The country where SomeCorp is registered (optional)
7. Optional: the user may ask the representative for the confirmation code

16. A system according to claim 12 wherein the Confirmation of Authenticity flow allows user to provide his contact particulars directly not via claimant.

17. A system according to claim 13 wherein the Confirmation of Authenticity flow includes at least some of the following operations:
1. User receives incoming call
2. Caller claims to be a representative of SomeCorp
3. User asks the representative to provide CoA using our service
4. The representative uses our widget/portal/service app to enter the user's phone number and (optionally) a textual message
5. The user goes to SomeCorp's website and using our widget on the site enters his phone number
6. Our portal looks for the user's phone number in the database and locates the relevant information with which to communicate with the user (phone platform type and version, identifier, etc.)
7. Our portal sends a secure notification to the user's device containing:
a. SomeCorp's name
b. The representative's name (optional)
c. The textual message entered by the representative (optional)
d. The country where SomeCorp is registered (optional)

18. A system according to any of the preceding claims wherein claimant uses at least one of the following to send a CoA to users:
Dedicated web portal
Dedicated widget on their internal service portal
their internal service portal
a dedicated service application on their smartphone

19. A system according to any of the preceding claims wherein claimant uses at least one of the following to request a CoA:
dedicated widget on a corporation's website
a browser extension
a smartphone application
a smartphone application with an SDK
an STK application installed on the SIM card
a native application on their mobile phone
a biometric scanner installed at the user's facility

20. A system according to any of the preceding claims wherein end-user uses at least one of the following for Receiving Confirmation of Authenticity from dedicated service:
a smartphone application via which secure push notifications may be received from our service
a smartphone application with an SDK via which secure push notifications may be received from our service
an STK application installed on the SIM card to receive encrypted notifications from our service
an integrated hardware component on their mobile phone to receive encrypted notifications from our service
a mobile phone which receives a secure identification of the caller via the mobile network's underlying protocols
a web browser connected to a web service (e.g. Facebook) through which secure notifications may be received
a 3rd party smartphone application (e.g. the Facebook smartphone application) via which secure push notifications may be received

21. A system operative for monitoring communications and identifying imposter tx communicants who are pretending to contact an rx end user from a telephone line associated with an organization which the imposter tx is not really calling from.

22. A system according to any of the preceding claims wherein the contact comprises telephone contact.

23. A system according to any of the preceding claims wherein the system informs each end user rx in real time of all instances in which registered telephone line in registered organization have called rx.

24. A system according to any of the preceding claims wherein said identifying occurs in real time.

25. A system according to any of the preceding claims wherein the system monitors incoming calls to each end user rx including identifying the telephone line from which each incoming call has ostensibly originated and, if the telephone line from which each incoming call has ostensibly originated is a registered telephone line in a registered organization, warning rx if the telephone line from which the incoming call has ostensibly originated has not really called rx.

26. At least one processor configured to perform at least one of or any combination of the described operations or to execute any combination of the described modules.

27. A method operative for monitoring communications and identifying imposter tx communicants who are pretending to contact an rx end user from a telephone line associated with an organization which the imposter tx is not really calling from.

28. A method for confirming authenticity of an organizational affiliation claim (claimed organizational affiliation), the method comprising:
Providing a database of organizations;
Using a server/processor to access the database; and
Via a channel of communication to end-users allowing end-users to receive from the processor an authentication of the claimed organizational affiliation.

29. A computer program product, comprising a non-transitory tangible computer readable medium having computer readable program code embodied therein, said computer readable program code adapted to be executed to implement a method operative for monitoring communications and identifying imposter tx communicants who are pretending to contact an rx end user from a telephone line associated with an organization which the imposter tx is not really calling from.

30. A computer program product, comprising a non-transitory tangible computer readable medium having computer readable program code embodied therein, said computer readable program code adapted to be executed to implement a method for confirming authenticity of an organizational affiliation claim (claimed organizational affiliation), the method comprising:
Providing a database of organizations;
Using a server/processor to access the database; and
Via a channel of communication to end-users allowing end-users to receive from the processor an authentication of the claimed (aka asserted) organizational affiliation.
